(19) United States
(12) Patent Application Publication
(10) Pub. No.: US 2020/0021870 A1
(43) Pub. Date: Jan. 16, 2020

(54) On Demand Digital Streaming for Use of Media Over the Internet

(71) Applicant: Jason Tyler Lechtenberg, Albuquerque, NM (US)

(72) Inventor: Jason Tyler Lechtenberg, Albuquerque, NM (US)

(21) Appl. No.: 16/509,935

(22) Filed: Jul. 12, 2019

Related U.S. Application Data
(60) Provisional application No. 62/697,704, filed on Jul. 13, 2018.

(51) Int. Cl. H04N 21/254; H04N 21/274

(52) U.S. Cl. CPC H04N 21/2541; H04N 21/274

(57) ABSTRACT

Embodiments of the present invention provide Video On Demand (VOD) services for remote use, e.g., at home, by streaming and viewing of purchased DVDs and Blu-rays by the owner of the purchased media by ensuring the owner owns the exact copy and is only viewing it at a single location at a time. Embodiments can also provide similar use and verification of streaming and listening to purchased CDs and audiobooks.

### CROSS REFERENCE TO RELATED APPLICATIONS

This application claims priority to U.S. provisional 62/697,704, filed Jul. 13, 2018, which is incorporated herein by reference.

### TECHNICAL FIELD

The present invention relates to Video On Demand (VOD) services for remote use, e.g., at home, by streaming and viewing of purchased DVDs and Blu-rays by the owner of the purchased media by ensuring the owner owns the exact copy and is only viewing it at a single location at a time. It further relates to the similar use and verification of streaming and listening to purchased CDs and audiobooks.

### BACKGROUND ART

Owners of physical disk media such as DVD, Blu-ray, music CD, audiobook CD, and other similar media formats (referred to herein as “Media”) often desire to do two things with their purchased and owned Media:

(1) View and listen to their purchased products with the modern convenience of Videon-On-Demand (VOD) streaming. DVD/Blu-ray players, and especially CD players, are becoming less and less common, leaving many owners of these Media with outdated options for viewing/listening to them.
(2) Reduce clutter in the house by eliminating large wall and floor space currently dedicated to holding rarely used Media and Media cases. Many owners of these disks and cases would like them out of sight and out of mind, just wanting to enjoy the media content they provide.

Many Media owners have already addressed the above by:

(1) Converting their Media collection to digital format. There are many applications available today to do this for free or for a small fee. HandBrake and WinX DVD Ripper are two examples.
(2) Setting up their own Network Attached Storage (NAS) servers and/or media servers (referred to herein as “NAS servers”) in their home to stream their content to all of their electronic devices. There are devices and applications for this purpose of streaming digital media files across a home's Local Area Network (LAN) and even the internet. Some examples include Synology NAS Media Server and Plex, both of which are a VOD service of a consumer's Media home library.
(3) Boxing up and putting their now unused physical Media into long term storage in their homes and/or storage units.

Many Media owners have not been able to solve these problems for themselves. Stumbling blocks for these Media owners include:

(1) The knowledge of how to convert their home Media collection to a convenient digital format. Essentially how to use tools like HandBrake and WinX DVD Ripper and what format and compression ratios to use.
(2) The time required to convert their Media library over to digital format. Converting a typical library of ˜300 DVD movies to digital format could easily take hundreds of hours for a novice.
(3) The knowledge of how to setup a stable and properly backed up NAS server to supply a VOD stream of their Media content to all of their devices.
(4) The time and skills required to provide regular software updates and hardware replacements for aging and failing parts over the years to NAS servers.

Millions of Media owners wish to use modern VOD services to view their Media content at home and on the go. Many of these users are already doing just that today by utilizing commonplace and market available software and hardware, as described above. However, due to technical knowledge and time limitations, many of these users are unable to utilize these same VOD type services for the same Media content as the more savoy users. Embodiments of the present invention can provide a solution for these Media owners that also preserves copyright protections of the Media artists.

### SUMMARY OF INVENTION

Embodiments of the present invention provide methods and apparatuses that protect and respect copyright protections while also serving Media owners without the knowledge and/or time to standup their own home-based VOD streaming service as many others are currently doing today. Various embodiments of the present invention are sometimes referred to herein as “Home Library.” Home Library is a trademark of its owner.

Home Library provides a new approach to streaming personally owned Media content. Home Library facilitates residential Media owners to easily view and stream their personally owned Media library through a company that provides VOD streaming services. Embodiments of the invention can guarantee absolutely that the customer owns the disk while it is streamed. This is different from existing media streaming companies which must stream content with the assumption that the customer does not already own the disk and movie for residential use. Home Library does this by uniquely combining three services.

Home Library can physically store the customers actual Media disks to ensure the customer does truly own those disks and that they are not loaned out, sold or stolen. This also frees the customer from having to store their physical disk collection themselves in their home.

Home Library can store the digital files for the use of only the customer who owns them. This also releases the customer from having to worry about standing up and maintaining their own NAS server and handling data loss, software updates, etc.

Home Library can stream the digital content of the user's disks to the customer in a VOD method. Only content that can be demonstrated to be owned by the customer will be streamed to the customer. Media content is not available to the public in any way. It is only available to the individual who purchased the content and provides the disk to Home Library as proof of current ownership.

Home Library can provide either, or both, of two approaches to a Home Library NAS server providing VOD streaming: (1) a company owns an NAS server, and (2) the Media owner owns a NAS server. In each case, a company utilizes the Home Library concept of the company storing the user's owned Media disks to ensure the content is owned by the customer. In some embodiments, both approaches can be used in combination.

### BRIEF DESCRIPTION OF DRAWINGS

FIGS. 1-5 are schematic illustrations of example embodiments of the present invention.

### DESCRIPTION OF EMBODIMENTS AND INDUSTRIAL APPLICABILITY

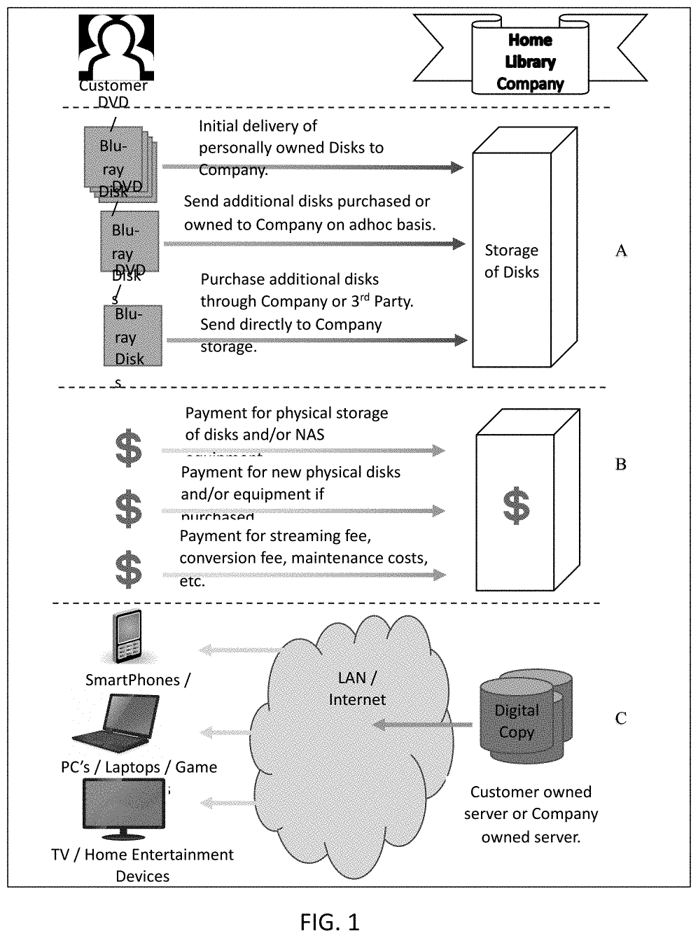

FIG. 1 is a schematic illustration of an example embodiment, and transactions involved with an example embodiment. In the figure, the Customer side corresponds to an individual customer who owns or acquires physical Media; there can be many such customers. The Home Library Company side corresponds to an entity that provides physical media storage and digital media conversion, storage, and streaming as described below. The Home Library Company can comprise a single business entity, and can comprise a plurality of companies—competing to provide all or a subset of the services, or cooperating such as by a physical storage company providing physical storage while a digital media company provides conversion and streaming. The example embodiment comprises a physical facility for storage of physical media items such as DVDs or CDs; a content storage facility such as a NAS; a communication network that allows streaming of content from the content storage to various content consumption devices such as smart phones, tablets, computers, and TVs; and control and authentication systems that provide for authentication and communications in support of transactions such as those below.

Customer sends their Media physical disks to the company. Customer retains full ownership and subsequent rights to the physical Media (e.g., DVDs). The company is simply storing these disks on behalf of the customer.

Company inventories and physically stores customers physical media disks and/or media cases to ensure ownership.

Customer can provide digital backups of their Media to the customer for the company to serve on a NAS drive that is owned by either the company or the customer.

Customer can pay company to convert their physical media disks to electronic digital format.

Customer can pay company to store their physical media disks.

Customer can pay company to stream their disk content back to them for home viewing.

Customer can only stream one-instance at a time of each disk they provided to the company.

Customer can only stream the exact version of the disk they own.

Company returns the disks to customer at end of contract, at which point streaming from company to customer is no longer allowed.

In section A of FIG. 1, all media items, e.g., disks, are owned by the customer and come with the rights associated with personal ownership. In this section, the Company is providing physical storage for physical media owned by the customer, not unlike many common storage arrangements. Section A also contemplates a Customer acquiring physical Media before making storage arrangements with the Company, acquiring physical Media from other parties, in each case subsequently transferring the physical media to the Company. Section A also contemplates a Customer acquiring physical Media from another party or from the Company, and having the physical Media delivered directly to the Company or physical storage facility without first being in possession of the Customer.

In section B of FIG. 1, a Customer can pay the Company to store physical Media, which payment can compensate the Company for shipping fees, stocking and returns, and inventory management; as well as the cost of real estate, staff, insurance, etc. A Customer can also purchase new physical Media from the Company, which physical Media can be stored by the Company without the cost of shipping the physical Media to the Customer and then back to the Company. A Company can offer discounts for storage or streaming of physical Media purchased from the Company, and can offer the same pricing without regard to whether the physical Media was purchased from the Company.

In an example embodiment where a Customer owns a NAS or similar equipment, the Customer can also pay fees to the Company for initial purchase, replacement, maintenance and support of such equipment. A Customer can also pay the Company for streaming of the content on the physical Media stored by the Company for the Customer, for example to compensate the Company for infrastructure necessary to provide such streaming, including as examples office space, content storage systems, electricity, internet connections and bandwidth, and cost of support and maintenance.

In section C of FIG. 1, the Company can store a unique digital copy of each physical Media. For example, if two Customers submit DVDs of Movie ABC, then the Company can store two digital copies of Movie ABC. Only the Customers who submitted Move ABC are allowed to stream the digital copies. The Company can alternately store a different number of copies of each unique content submitted, for example storing only enough copies to satisfy anticipated streaming demand. For example, if two Customers submitted physical Media having Movie ABC, the Company can store a single digital copy (though still storing the two separate physical Media devices), and stream from that copy only to Customers who submitted the physical Media.

The Company can also limit streaming to the content on the physical Media submitted by each Customer. As an example, if Customer A submitted a conventional DVD of Movie ABC, then Customer A can stream only the conventional DVD content, and not Blu-ray content or special features that were included on other releases but were not included on the physical Media submitted by that Customer. Software maintained by the Company can match Customer login credentials with content rights so that Customer access is limited to content that the Customer owns. The Company can also limit streaming to only the number of simultaneous streams that does not exceed the number of physical Media devices submitted; e.g., if a Customer submits one DVD of Movie ABC, the Customer is allowed to have only one active stream of Movie ABC at a time (similar to the limitations that would be present if viewing using the physical Media). A Customer can loan a DVD to another party by authorizing the party to access the Customer's authorized stream, but the Customer cannot stream the loaned content while the party is streaming it (similar to the limitations that would be present if the physical Media was loaned).

The Company can allow streaming to a variety of platforms, including as examples phones (Android, Apple, Windows, etc.), computer devices (PC, Macs, gaming consoles, etc.), home entertainment systems (TV, Roku, AppleTV, etc.), internet website, to their “smart” sunglasses, contact lens, eye glasses, virtual reality equipment, etc. The company can provide multiple streaming service, for example various video and audio quality levels, and single or multiple IP addresses to support individual and family plans, and can charge different fees for different levels of service.

In some embodiments, the Company owns the digital storage facilities and related equipment. The Company can co-locate content from multiple Customers on a single storage system, and use control software to manage Customer access and ensure that Customers only stream content owned by the Customer. The Company can also use a single NAS or other digital storage system for a single Customer. In some embodiments, the Customer owns the digital storage system, which is located at a facility controlled by the Company. The Company can maintain the storage system, perform backups and upgrades, reducing the burden on the Customer. In some embodiments, the Customers owns the digital storage system, and maintains it in a facility controlled by the Customer (e.g., at the Customer's residence). The Company can provide remote support for the storage facility, and can provide a ready to use storage facility when the Customer requests.

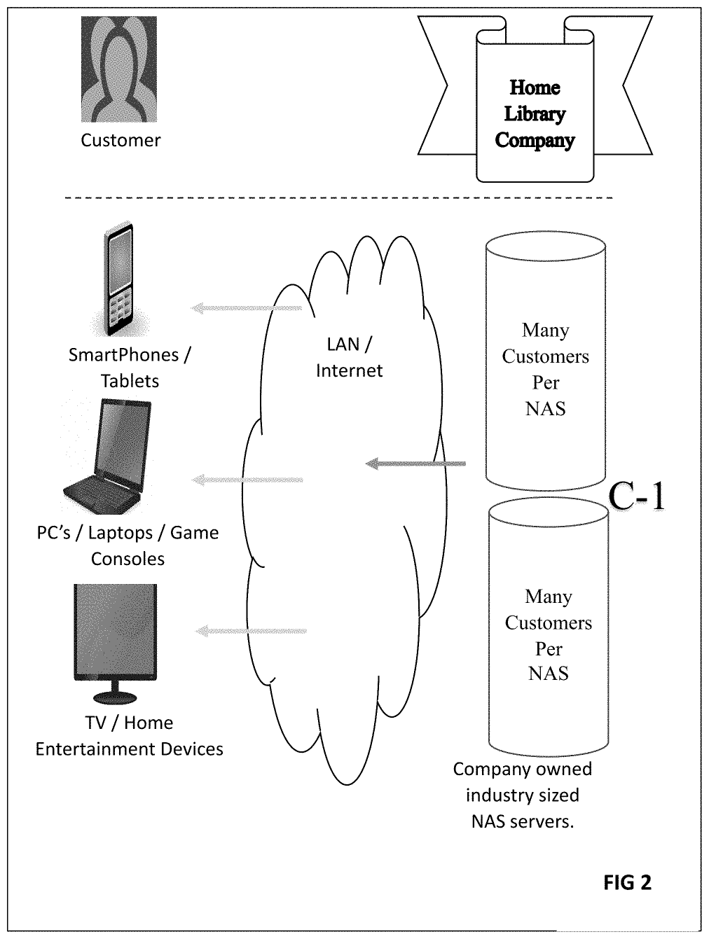

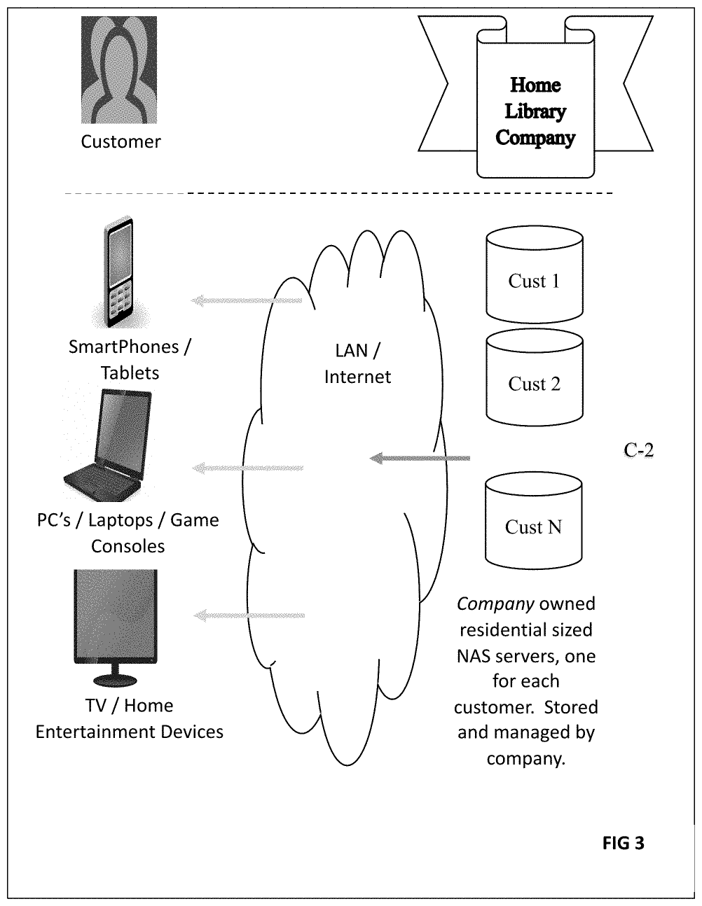

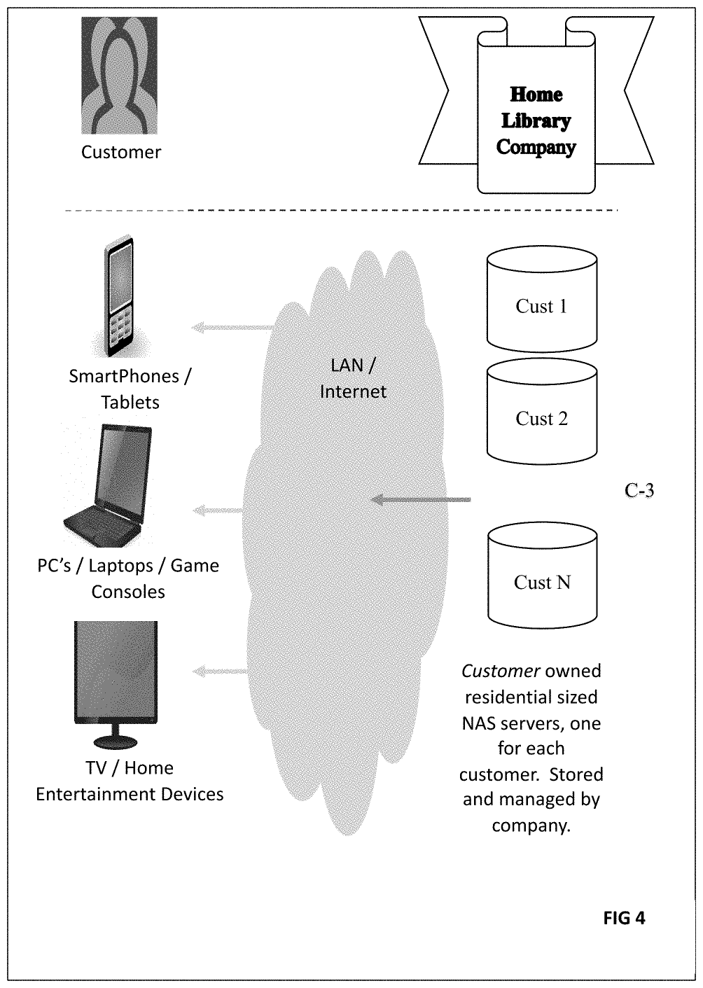

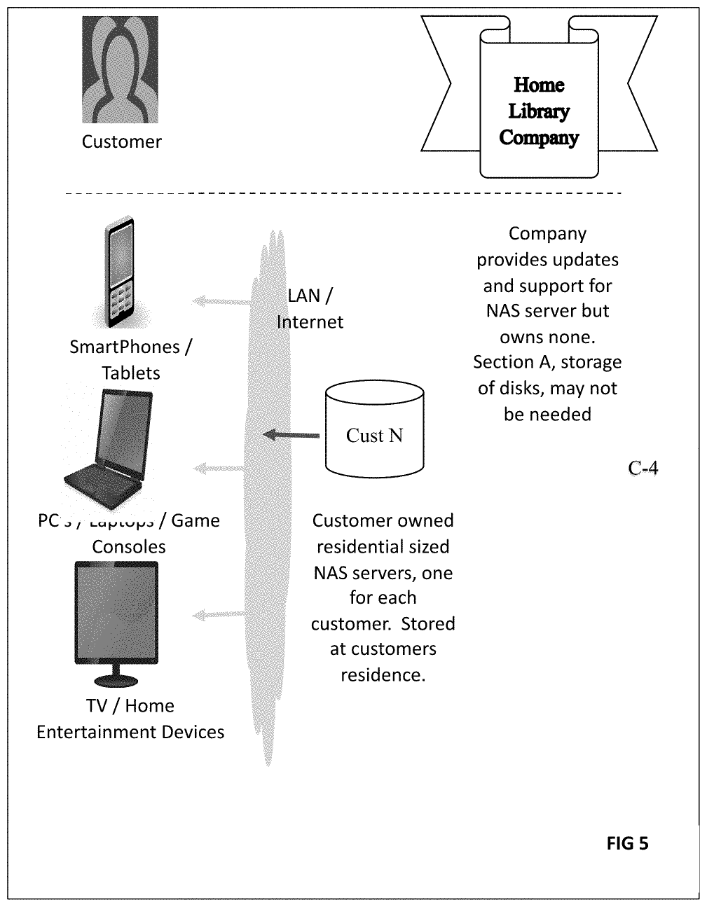

FIGS. 2-5 are schematic illustrations of some of the various example embodiments described above.

Embodiments of the present invention can be combined with current streaming services such as Netflix, where the Customer can select content available from the streaming service as well as content stream-able due to deposit of physical Media as described above. Since the physical Media is correlated with Customers who typically have physical residences to which they most often stream content, the digital storage facilities can be geographically dispersed to allow greater use of local network connections and reduce demand on long distance or cross-country network bandwidth. As an example, a Company can focus on a particular town or city, and then both physical Media deliveries and streaming content will be largely limited to the short distances necessary to traverse that particular town or city.

Example Implementations.

Control systems to implement operations can be implemented in computer software. As an example, a control system can be used to document, record, and access customer and media information records. Examples of useful information include customer address, payment information, owned media disks, viewing records, etc.

A control system can be implemented using a relational database software tool such as SQL, Microsoft Access, or other. Information can be organized in tables such as:

Customer—CustomerID, Name, Address, PhoneNumber, etc. Each customer to HLC has their own record.
Media—MediaID, Title, Year Released, Format (DVD, Blu-Ray, etc.), Length, etc. Each unique media art that customers may own has its own record. Noting that different versions and content of the same movie each have their own record.
StorageLocation—BinID, Location, Capacity, Type, etc. Each bin/spindle/box used for physical storage of customers media will have its record.
Disk—DiskID, MediaID, CustomerID, StorageID, etc. Each physical disk has its own record, which is tied to the Media it contains, the Customer who owns it, the Storage bin its located in.
Invoice—InvoiceID, CustomerID, Payment, DueDate, ReceivedDate, InvoiceState, etc. Each payment required by a customer will have its own record.
Server—ServerID, Make, Model, MemoryInstalled. Each server used by HLC has its own record.
View—ViewID, CustomerID, DiskID, ServerID, IPAddressFrom, IPAddressTo, Date, Time, Duration, ViewState, etc. Every VOD viewing of a movie by a customer generates a new View record of its details, including if it's still actively being streamed or if the streaming is completed.
Loan—LoanID, OwnerID, BorrowerID, DiskID, StartTime, EndTime Any media disk loans allowed by HLC will generate a record of the loan so the current customer able to the view the disk at any time is always known.
Transaction—TransactionID, NewOwnerID, PrevOwnerID, DiskID, Date, Price A record will be generated for every customers who sell their physical media disks to another customer.

A control system can provide forms to facilitate creation and update of records in the database, including forms such as:

### New Customer.

### Generate Customer Invoice.

Update Customer Invoice (payment received, apply discount, etc.).

### Add Disk.

### Remove Disk.

### Loan Disk.

### Buy Disk.

### Stream Disk.

### Update Disk Location.

### Add Server.

A control system can accommodate queries such as:

Customers Views by Date with IP address used and Server used.

### Customers Payments by Date.

Customers disks available for streaming right now.

### All Disks in a Bin ID.

All Disks being stored by HLC.
All Media content stored by HLC.
All Disks currently being streamed right now.
All Customers currently streaming right now.

A system can be implemented using third party software to manage access. An example implementation is described below.

Home Library company (HLC) utilizes a Synology NAS running Video Station Server.

New customer joins HLC and provides their physical media library.

HLC creates a new user account on the Synology NAS drive and sets up proper access controls to Video Station such that the customer can only view movies they provided physical media for. Each customer has their own account, password, and access controls to their provided media.

Customer uses the Synology App DS Video to access their account via their smart phones, smart TV's, Roku devices, etc. Customer logs in with their user name and password. DS Video only gives them access to their owned media.

This scenario can utilize much of the Controls System database, although many of the updates to the database will be manual, as Synology NAS Video Station does not generate HLC database entries automatically.

A system can be implemented using custom software to manage access. An example implementation is described below.

HLC deploys custom server software capable of:

Real-time interactions with HLC Control System database.
Ability to stream movies from a NAS drive to a customer on demand while updating Controls System database automatically.

HLC deploys custom client software capable of:

Real-time interactions with Customers via their devices (phones, TV's, website, etc.). Customer login with password, view account details, media available, viewing history, etc.
Streaming media content to their devices.

The present invention has been described in connection with various example embodiments. It will be understood that the above description is merely illustrative of the applications of the principles of the present invention, the scope of which is to be determined by the claims viewed in light of the specification. Other variants and modifications of the invention will be apparent to those skilled in the art.

We claim:

1. A system for storage and streaming of digital content while maintaining copyright protections, comprising:
(a) a physical storage facility, configured to store a plurality of physical media items;
(b) a digital storage facility, configured to store digital content corresponding to digital content on the plurality of physical media items;
(c) a control system, configured to correlate a customer with one or more of the plurality of physical media items to which the customer has rights;
(d) an access system, configured to provide a customer access to digital content corresponding to physical media items correlated with the customer by the control system, and to deny the customer access to digital content corresponding to physical media items not correlated with the customer by the control system.

2. A system as in claim 1, wherein the physical media items comprise DVDs and Blu-rays

3. A system as in claim 1, wherein the digital storage facility comprises a solid state storage system, a disk storage system, or a combination thereof.

4. A system as in claim 1, wherein the digital storage system is owned by the customer, at their residence or not.

5. A system as in claim 1, wherein the control system comprises computer software.

6. A system as in claim 1, wherein the access system is configured to access content from the digital storage facility and stream it using a computer network to a device indicated by the customer.
